(19) United States
(12) Patent Application Publication
(10) Pub. No.: US 2010/0226128 A1
(43) Pub. Date: Sep. 9, 2010

(54) Lamp

(75) Inventor: Philipp VAN BEECK, Paderborn (DE)

Correspondence Address: COHEN, PONTANI, LIEBERMAN & PAVANE LLP, 551 FIFTH AVENUE, SUITE 1210, NEW YORK, NY, 10176, US

(73) Assignee: e:cue control GmbH, Paderborn (DE)

(21) Appl. No.: 12/700,659

(22) Filed: Feb. 4, 2010

(30) Foreign Application Priority Data
Feb. 5, 2009 (DE) 10 2009 007 496.1

(51) Int. Cl. F21V 1/00

(52) U.S. Cl. 362/235

(57) ABSTRACT

A lamp (100), having a plurality of light-emitting diodes (1), a focusing optical element (10, 11) being arranged downstream of each light-emitting diode (1), an electrically adjustable diffuser (3), which is arranged downstream of the focusing optical element (10, 11) in a main beam direction of the light-emitting diodes (1), and a control device (4), which is connected to the diffuser (3) and by means of which the light-scattering properties of the diffuser (3) may be adjusted.

### RELATED APPLICATION

This application claims the priority of German patent application no. 10 2009 007 496.1 filed Feb. 5, 2009, the entire content which is hereby incorporated by reference.

### FIELD OF THE INVENTION

The present invention is related to a lamp including a plurality of light-emitting diodes.

### SUMMARY OF THE INVENTION

One object of the present invention is to provide a lamp which is particularly versatile.

The lamp is for example a lamp for illuminating the interior or exterior of a building.

According to an embodiment of the lamp, the lamp comprises a plurality of light-emitting diodes, which form the light sources of the lamp. The light-emitting diodes are for example RGB light-emitting diodes, which comprise at least one semiconductor chip that emits light in the red range of the spectrum, one semiconductor chip which emits light in the green range of the spectrum and one semiconductor chip which emits light in the blue range of the spectrum.

A focusing optical element is arranged downstream of each light-emitting diode of the lamp. In this context, “arranged downstream” means that substantially all the light emitted by the light-emitting diode passes through the optical element. “Substantially” means that at least 90% of the light emitted by the light-emitting diode passes through the optical element.

The light cone of the light emitted by the light-emitting diodes when the lamp is in operation is reduced in width by the focusing optical element. This means, for a predetermined area to be illuminated, that in the case of a light-emitting diode with focusing optical element the light from the light-emitting diode impinges on a smaller portion of the area than would be the case without the focusing optical element.

According to an embodiment of the lamp, the lamp comprises an electrically adjustable diffuser, which is arranged downstream of the focusing optical element in the main beam direction of the light-emitting diodes. Here “arranged downstream” means that the light from the light-emitting diodes focused by the optical element or the optical elements impinges on the diffuser and passes through it. Preferably at least 85% of the light produced by the light-emitting diodes when in operation impinges on the diffuser.

The diffuser is an electrically adjustable diffuser. This means that the light-scattering properties of the diffuser may be modified for example by applying an external electrical voltage. The diffuser comprises at least one operating state, in which it is transparent to the light passing through. In this case the diffuser displays no or barely any light-scattering action. The diffuser may have at least a second operating state, in which it displays a significant light-scattering action similar to a pane of opal glass. It is additionally possible for the diffuser to have at least one intermediate state of light-scattering action. This means that the light-scattering action of the diffuser may be variable in stages or continuously, for example by means of the level of voltage applied.

According to an embodiment of the lamp, the lamp further comprises a control device, which is connected to the diffuser. The light-scattering properties of the diffuser may be adjusted by means of the control device. The control device for example modifies a voltage which is applied to the electrically adjustable diffuser and in this way adjusts the light-scattering properties of the diffuser. Adjustment of the light-scattering properties may here proceed as a function of external inputs, which are input into the control device for example by a main control device or a user.

According to an embodiment of the lamp, the lamp comprises a plurality of light-emitting diodes, a focusing optical element being arranged downstream of each light-emitting diode. In addition, the lamp comprises an electrically adjustable diffuser, which is arranged downstream of the focusing optical element in the main beam direction of the light-emitting diodes. Finally, the lamp comprises a control device, which is connected to the diffuser, by means of which the light-scattering properties of the diffuser may be adjusted. In the simplest case, the control device may switch the light-scattering action of the diffuser from transparent to maximally scattering. It is additionally possible for the control device to modify the light-scattering action of the diffuser from transparent to maximally light-scattering in at least two, i.e. in a plurality of stages.

The components of the lamp, i.e. the light-emitting diodes, the optical elements, the diffuser and the control device are combined to form a lamp, i.e. the components are arranged for example on a common support and/or in a common lamp housing.

The lamp described here makes use inter alia of the following concept: lamps are conventionally divided into two types, i.e. one possible type of lamp is a “spot”, with which the light produced is focused onto a narrowly defined surface area, and another possible type of lamp is a “washer”, by means of which a room may be lit as uniformly as possible.

Combining light-emitting diodes having a focusing optical element, which perform the “spot” function, and an electrically adjustable diffuser, by means of which a lamp may be adjusted to perform a “washer” function, allows the two lamp types to be united in a single lamp. Furthermore, it is then possible with the proposed lamp to make it possible to select intermediate states between the two lamp functions. To this end, the electrically switchable diffuser is used to establish a light-scattering action which lies between that of transparent diffuser and that of maximally light-scattering diffuser.

In addition, in the light-scattering state the diffuser may bring about homogeneous mixing of the light produced by the light-emitting diodes. In this way, for example, homogeneous mixing of the emitted light color may take place when single color LEDs are used.

Such a diffuser may take the form for example of liquid crystals, to which an external voltage is applied. This means that at least one layer of liquid crystals is arranged between two transparent electrodes. By applying an electrical voltage to the electrodes the unordered liquid crystals may be oriented. While unordered liquid crystals scatter diffusely light which impinges on them, radiation may pass through unhindered if the liquid crystals are uniformly oriented. This renders the diffuser transparent to the light impinging on it.

In other words the control device makes it possible to adjust the width of the light cone of the light emitted by the lamp when in operation. The more intensely the adjustable diffuser scatters the light passing through it, the wider is the light cone of the light emitted by the lamp when in operation. The light cone of the lamp is defined, for example, in that at the edge of the light cone the intensity of the light emitted by the lamp has dropped to 30% of the maximum intensity of the light emitted by the lamp. Outside the light cone the intensity of the light emitted by the lamp is then less than 30% of the maximum intensity of the light emitted by the lamp.

According to an embodiment the diffuser takes the form of a foil. The diffuser is then an electrically adjustable diffusion foil. This foil may for example be adhesively bonded directly onto a transparent lamp cover disc, which is arranged downstream of all the light-emitting diodes. It is furthermore also possible to apply the foil to the outer surface of the focusing optical element, if the lamp comprises precisely one such focusing optical element for all the light-emitting diodes.

For example the foil may be such that transparent electrodes, for example made from a TCO (transparent conductive oxide) material such as ITO, are applied, for example vapour-deposited, onto a plastics film, which forms the support for the respective electrode. Between these electrodes a layer with liquid crystals is then arranged.

According to an embodiment of the lamp, a common focusing optical element is arranged downstream of all the light-emitting diodes. This means that light from all the light-emitting diodes passes through a common focusing optical element. In this case it is also possible for the light-emitting diodes themselves also to bear an additional, focusing optical element, which is assigned on a one-to-one basis to each light-emitting diode. It is additionally possible to dispense with a common focusing optical element, and for the light-emitting diodes each to comprise a focusing optical element assigned on a one-to-one basis. This focusing optical element may then for example comprise encapsulation for the light-emitting diode chip of the light-emitting diode, said encapsulation comprising an outer surface curved in lenticular manner.

According to an embodiment, in the main beam direction of the light-emitting diodes the one-to-one assigned optical element directly follows the assigned light-emitting diode, the common focusing optical element directly follows the one-to-one assigned optical element and the electrically adjustable diffuser directly follows the common focusing optical element. “Follow directly” here means in particular that no further optical elements are arranged between the components. The components are then either in direct contact with one another or a gas such as air is arranged between them.

According to an embodiment of the lamp, the lamp comprises a terminal carrier. The terminal carrier is for example a printed circuit board with an electrically insulating base member, on or in which terminals and conductive tracks for the light-emitting diodes are structured. For example, the terminal carrier may be a metal core board or a printed circuit board with a plastics base member. Preferably the light-emitting diodes are arranged on the top of the terminal carrier. There they are fastened to terminals of the terminal carrier and may be electrically contacted by means of conductive tracks.

According to an embodiment of the lamp, the control device for the diffuser is arranged on the bottom, opposite the top, of the terminal carrier. This permits a particularly space-saving lamp structure. To this end the terminal carrier preferably comprises terminals and conductive tracks both on its top and on its bottom. In addition, the terminal carrier may comprise a via, by means of which the terminals and conductive tracks on the two different sides of the terminal carrier are connected together in an electrically conductive manner. Further electronic components, for example for actuating the light-emitting diodes, may then be arranged on the bottom of the terminal carrier.

According to an embodiment of the lamp, the lamp comprises a plurality of light-emitting diodes, which in each case have a power consumption of at least 1 watt, preferably of at least 3 watts. For example 18 or more such light-emitting diodes may be used in the lamp. In this way the lamp is particularly suitable for general lighting.

### BRIEF DESCRIPTION OF THE DRAWINGS

The lamp described here is explained in greater detail below with reference to exemplary embodiments and the associated figures.

FIG. 1 is a schematic sectional representation of a first exemplary embodiment of a lamp described herein.

FIG. 2 is a schematic sectional representation of a second exemplary embodiment of a lamp described herein.

FIG. 3 is a schematic sectional representation of a lamp described herein showing the mode of operation of the diffuser.

### DETAILED DESCRIPTION OF THE DRAWINGS

In the exemplary embodiments and figures, identical or identically acting components are in each case provided with the same reference numerals. The elements shown should not be considered to be to scale, but rather individual elements may be shown exaggeratedly large to assist in understanding.

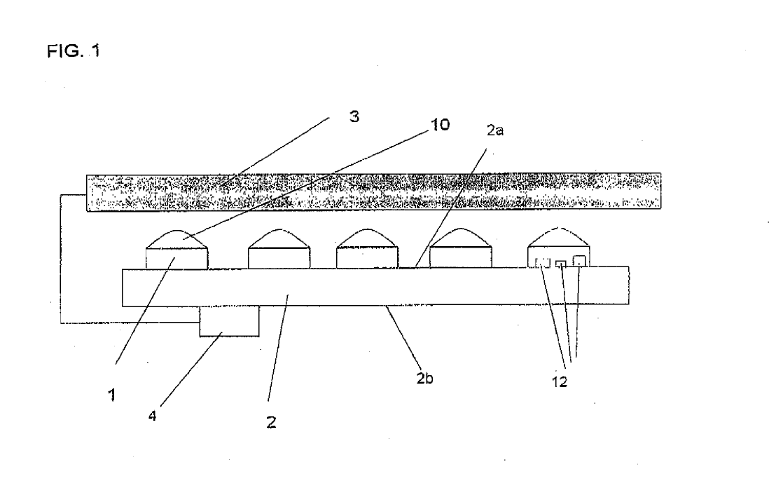

FIG. 1 is a schematic sectional representation of a first exemplary embodiment of a lamp described herein. The lamp comprises a plurality of light-emitting diodes 1. Downstream of each light-emitting diode 1 in the beam direction there is arranged a focusing optical element 10, which may for example comprise a lenticular encapsulation for the light-emitting diode chip 12 of the light-emitting diode 1. Each light-emitting diode comprises for example three light-emitting diode chips 12, which emit for example red, blue and green light.

The light-emitting diodes 1 are applied to a terminal carrier 2, which may for example be a large-area printed circuit board, on the top 2a and bottom 2b of which conductive tracks and terminals (not shown in either case) are printed. 18 or more, for example 64, light-emitting diodes 1 may for example be arranged on the terminal carrier.

On the bottom 2b of the terminal carrier there is located least one control device 4, which is connected electrically conductively to an electrically switchable diffuser 3. The electrically switchable diffuser 3 may be an electrically switchable diffuser foil.

When the lamp is in operation, first of all the light produced by the light-emitting diodes 1 is focused by the focusing optical element 10 of each light-emitting diode. If the electrically switchable diffuser 3 is switched to transparent, the lamp produces a light cone 63 of small width (see FIG. 3). By for example modifying the voltage which is applied to the electrically switchable diffuser 3, the width of the light cone is enlarged. The maximum width is obtained for the light cone 61, the diffuser here having achieved its maximum light-scattering action. In intermediate states a light cone 62 may for example be obtained which has a larger width than the light cone 63 and a smaller width than the light cone 61.

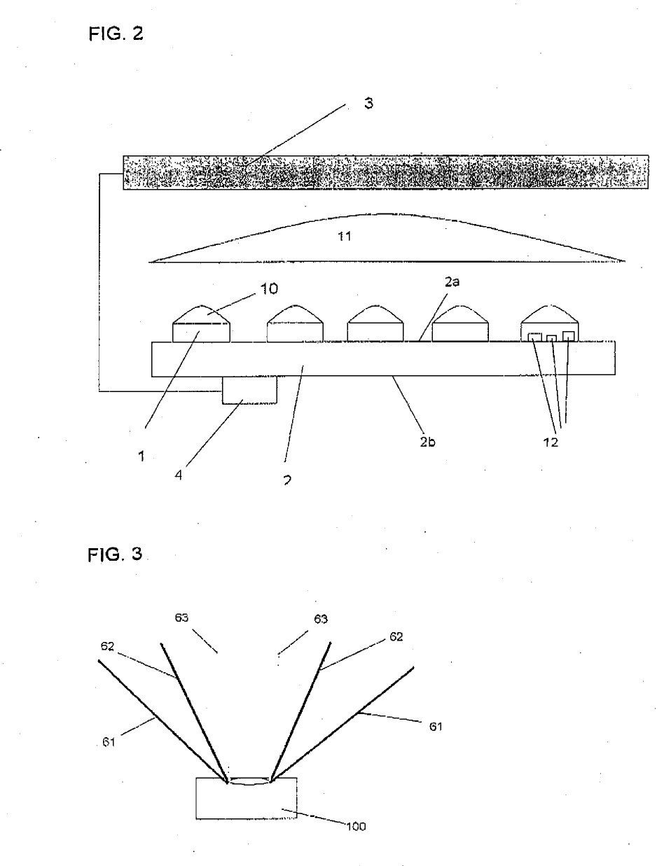

A further exemplary embodiment of a lamp described herein is explained in greater detail in conjunction with FIG. 2. In this exemplary embodiment a common focusing optical element 11 is arranged downstream of the light-emitting diodes 1 with their focusing optical elements 10. This focusing optical element may for example be a converging lens, which may also take the form of a Fresnel lens. It is possible, by means of the further optical element 11, to concentrate the light produced by the light-emitting diodes 1 to an even greater extent and thus, in the case of a transparent diffuser, to produce a light cone which is of a particularly small width.

The proposed lamp may be used for example for room lighting. It may have an operating state in which it may be used as a reading lamp, wherein its light is focused onto a particularly small surface area. By increasing the light-scattering action of the diffuser, the lamp may be changed over from reading lamp to room light, the latter illuminating a room particularly uniformly.

The description made with reference to the exemplary embodiments does not restrict the invention to these embodiments. Rather, the invention encompasses any novel feature and any combination of features, including in particular any combination of features in the claims, even if this feature or this combination is not itself explicitly indicated in the claims or exemplary embodiments.

I claim:

1. A lamp comprising:
a plurality of light-emitting diodes, at least one focusing optical element being arranged downstream of each light-emitting diode in a main beam direction of the light-emitting diodes;
an electrically adjustable diffuser, which is arranged downstream of the at least one focusing optical element in a main beam direction of the light-emitting diodes; and
a control device, which is connected to the diffuser, control device being configured to adjust the light-scattering properties of the electrically adjustable diffuser.

2. The lamp according to claim 1,
wherein a focusing optical element is assigned on a one-to-one basis to each light-emitting diode, and
wherein a converging lens provided as a common focusing optical element is arranged downstream of all the light-emitting diodes.

3. The lamp according to claim 2,
wherein in the main beam direction of the light-emitting diodes the one-to-one assigned optical element directly follows the assigned light-emitting diode, the common focusing optical element directly follows the one-to-one assigned optical element and the electrically adjustable diffuser directly follows the common focusing optical element.

4. The lamp according to claim 1,
wherein the width of the light cone of the light emitted by the lamp when in operation is adjustable by means of the control device.

5. The lamp according to claim 1,
wherein the diffuser takes the form of a foil.

6. The lamp according to claim 1,
wherein a common focusing optical element is arranged downstream of all the light-emitting diodes in a main beam direction of the light-emitting diodes.

7. The lamp according to claim 6,
wherein the common focusing optical element is a converging lens.

8. The lamp according to claim 1,
wherein a focusing optical element is assigned on a one-to-one basis to each light-emitting diode.

9. The lamp according to claim 1,
wherein the light-emitting diodes are arranged on the top of the terminal carrier.

10. The lamp according to claim 9,
wherein the control device for the diffuser is arranged on the bottom, opposite the top, of the terminal carrier.

11. The lamp according to claim 1, wherein
each of the light-emitting diodes comprises at least three light-emitting diode chips, whose light may be mixed to produce white light.

12. The lamp according to claim 1, wherein
each of the light-emitting diodes has a power consumption of at least 1 watt.

13. The lamp according to claim 1, comprising at least 18 light-emitting diodes, which each have a power consumption of at least 1 watt.
